(19) United States
(12) Patent Application Publication
(10) Pub. No.: US 2014/0068378 A1
(43) Pub. Date: Mar. 6, 2014

(54) SEMICONDUCTOR STORAGE DEVICE AND MEMORY CONTROLLER

(71) Applicant: KABUSHIKI KAISHA TOSHIBA, Tokyo (JP)

(72) Inventors: Kenichiro YOSHII, Tokyo (JP); Naoaki Kokubun, Kanagawa (JP); Naoto Oshiyama, Tokyo (JP); Ryo Yamaki, Kanagawa (JP); Ikuo Magaki, Kanagawa (JP); Kenta Yasufuku, Kanagawa (JP); Akira Yamaga, Kanagawa (JP)

(73) Assignee: Kabushiki Kaisha Toshiba, Tokyo (JP)

(21) Appl. No.: 13/772,659

(22) Filed: Feb. 21, 2013

Related U.S. Application Data
(60) Provisional application No. 61/695,784, filed on Aug. 31, 2012.

(51) Int. Cl. G06F 11/10

(52) U.S. Cl. CPC G06F 11/1008
USPC 714/764

(57) ABSTRACT

According to an embodiment, a semiconductor storage device includes a memory, an encoding unit that generates a parity, and a decoding unit that includes a syndrome calculating unit, an error position polynomial calculating unit, and an error searching and correcting unit, and performs an error correcting process based on data and the parity read from the memory. At the time of performing a compaction process, a process of the error searching and correcting unit is not performed, when the number of error bits acquired by an error position polynomial is equal to or less than a first threshold value based on valid data.

### CROSS-REFERENCE TO RELATED APPLICATIONS

This application is based upon and claims the benefit of priority from Provisional Patent Application No. 61/695,784, filed on Aug. 31, 2012; the entire contents of which are incorporated herein by reference.

### FIELD

Embodiments described herein relate generally to a semiconductor storage device and a memory controller.

### BACKGROUND

In non-volatile semiconductor memory such as NAND flash memory, a strong error correction scheme needs to be used at the time of recording data, as cells serving as storage elements are miniaturized. For example, when data of 1 KB is recorded, a parity is generated through an error correction coding (ECC) process of correcting an error of 40 bits and the parity is recorded along with the data. The original data is reproduced by performing the error correcting process using the parity at the time of reading the data. However, in recent years, a required error correction capability has been increased, and thus the ECC with a correction capability of 100 bits or more with respect to a unit data size will be necessary in the near future. When the strong ECC is used, it takes a time to perform the correction process.

In a case of a semiconductor storage device using a NAND flash memory, data may not be written in a region on which data has been already written, if data is not once erased in a unit called a block. For this reason, when unnecessary data is present in a block, a process (here, referred to as a compaction process) is performed to fill and copy valid data present in the block to another block so that a copy source block can be erased.

When data is read from a NAND flash memory, an error correcting process is performed on the data and the parity read from the NAND flash memory, and thus correct data is restored. In the compaction process, when the data is read to copy the data, the error correcting process is performed. Then, the data is written on a copy destination block, after the error correction coding process is performed again.

In regard to a reading request from a user, the data received at the time of making a writing request from the user needs to be restored completely through the error correcting process and to be transmitted. However, the compaction process is not a process of transmitting data to a user, but is a process of moving data within a semiconductor storage device. Thus, correcting an error bit completely at the time of reading data from a non-volatile storage memory in the compaction process is merely an overhead to the user.

### BRIEF DESCRIPTION OF THE DRAWINGS

FIG. 1 is a diagram illustrating an example of the configuration of a semiconductor storage device according to a first embodiment.

FIGS. 2A to 2D are diagrams illustrating an example of a compaction process in the semiconductor storage device.

FIGS. 3A to 3D are diagrams illustrating an example of valid data bitmap data.

FIG. 4 is a diagram illustrating an example of the configuration of a decoding unit according to the first embodiment.

FIG. 5 is a flowchart illustrating an example of the order of an error correcting process in a memory controller according to the first embodiment.

FIGS. 6A and 6B are diagrams illustrating examples of error distributions.

FIG. 7 is a flowchart illustrating an example of the order of an error correcting process according to a second embodiment.

FIG. 8 is a diagram illustrating an example of a threshold setting table according to a third embodiment.

FIG. 9 is a diagram illustrating an example of a threshold setting table according to a fifth embodiment.

FIG. 10 is a diagram illustrating an example of a threshold setting table according to a sixth embodiment.

### DETAILED DESCRIPTION

In general, according to one embodiment, a semiconductor storage device includes: a non-volatile semiconductor memory; an encoding unit that performs an error correction coding process on data to be written on the non-volatile semiconductor memory to generate a parity; a writing control unit that writes the data and the parity on the non-volatile semiconductor memory; a decoding unit that performs an error correcting process based on the data and the parity read from the non-volatile semiconductor memory; and a compaction processing unit that performs a compaction process of writing valid data of the data and the parity stored in a first region of the non-volatile semiconductor memory on a second region other than the first region of the non-volatile semiconductor memory. The semiconductor storage device includes: a syndrome calculating unit that calculates a syndrome; an error position polynomial calculating unit that acquires the number of error bits based on an error position polynomial; and an error searching and correcting unit that acquires an error position and performs error correction. At the time of performing the compaction process, the decoding unit performs the processes of the syndrome calculating unit and the error position polynomial calculating unit based on the valid data and writes the valid data on the second region without performing the process of the error searching and correcting unit, when the number of error bits acquired by the error position polynomial calculating unit is equal to or less than a first threshold value.

A semiconductor storage device and a memory controller according to the embodiments will be described in detail below with reference to the attached drawings. The present invention is not limited by these embodiments.

### First Embodiment

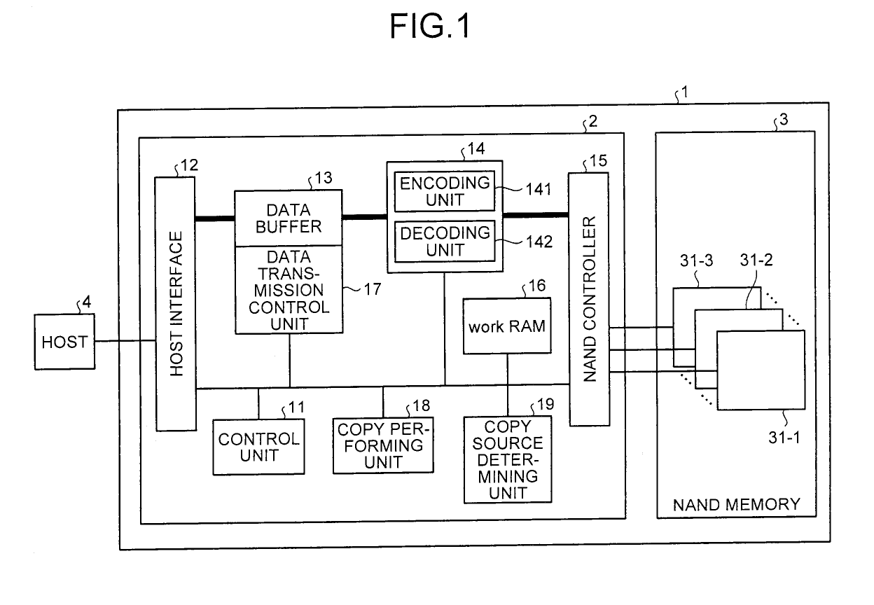

FIG. 1 is a diagram illustrating an example of the configuration of a semiconductor storage device according to a first embodiment. As illustrated in FIG. 1, a semiconductor storage device 1 according to the embodiment includes a memory controller 2 and a NAND memory (a NAND flash memory and a non-volatile semiconductor memory) 3.

The semiconductor storage device 1 is connectable to a host 4. FIG. 1 illustrates the semiconductor storage device 1 connected to the host 4. The host 4 is, for example, an electronic apparatus such as a personal computer or a portable terminal. The semiconductor storage device 1 is a data storage device that performs main processes of receiving read and write commands from the host 4, and reading and writing data from and to the NAND memory 3.

The memory controller 2 controls the entire memory controller 2. The memory controller 2 includes a control unit 11 that performs writing write data received from the host 4 in the NAND memory 3, reading read data requested from the host 4 from the NAND memory 3, and the like; a host interface 12 that performs exchanging data with the host 4; and a data buffer 13 that temporarily stores the data exchanged with the host 4 and copy data to be described below. The memory controller 2 further includes a data transmission control unit 17 that controls data transmission between the data buffer 13 and the NAND memory 3 and data transmission between the host 4 and the data buffer 13 via the host interface 12; and a NAND controller 15 that controls the NAND memory 3.

The memory controller 2 further includes an error correcting unit 14 that performs an error correction coding process based on data written on the NAND memory 3 and performs an error correcting process on data read from the NAND memory 3; a copy source determining unit 19 that determines data to be copied; a work random access memory (RAM) 16 that is used for the copy source determining unit 19 to perform a process; and a copy performing unit 18 that copies the data determined by the copy source determining unit 19. The error correcting unit 14 includes an encoding unit 141 and a decoding unit 142.

The NAND memory 3 includes memory chips 31-1 to 31-3. The NAND controller 15 includes a plurality of channels corresponding to the memory chips, respectively, and performs reading and writing data from and on the NAND memory 3 for each channel. In FIG. 1, three memory chips are illustrated, but the number of memory chips and the number of channels are not limited thereto.

Next, the entire operations of writing data on the NAND memory 3 and reading data from the NAND memory 3 in the semiconductor storage device 1 will be described.

The host interface 12 performs a process in conformity with an interface standard between the host interface 12 and the host 4. The host interface 12 transmits a command received from the host 4 to the control unit 11 and outputs user data received from the host 4 to the data buffer 12. The host interface 12 transmits user data read from the NAND memory 3, a response from the control unit 11, and the like to the host 4.

The NAND controller 15 controls a process of writing write data on the NAND memory 3 and a process of reading the write data from the NAND memory 3 in response to an instruction of the control unit 11.

When the control unit 11 receives a command from the host 4 via the host interface 12, the control unit 11 performs control in accordance with the command. For example, the control unit 11 instructs the NAND controller 15 to write code words (user data and a parity) in the NAND memory 3, read code words from the NAND memory 3, and the like in accordance with a command from the host 4.

The encoding unit 141 of the error correcting unit 14 performs the error correction coding process to generate a parity based on the user data stored in the data buffer 13. Any code may be used as the error correction code. For example, a BCH code or the like can be used. In the following description, a use example of the BCH code will be described, but the error correction code is not limited thereto.

The decoding unit 142 performs a decoding process based on the code words (the user data and the parity) read from the NAND memory 3. When there is no error in the user data, the user data read from the NAND memory 3 is output to the data buffer 13. When there is an error in the user data, the user data is subjected to the error correcting process, and then is output to the data buffer 13. The user data processed by the decoding unit 142 is transmitted to the host 4 via the host interface 12.

Next, a compaction process in the semiconductor storage device 1 will be described. In the NAND flash memory, data may not be written in a region on which data has been already written, if data is not once erased in a unit called a block. For this reason, when unnecessary data is present in a block, a compaction process of filling and copying valid data present in the block to another block so that a copy source block can be erased is performed.

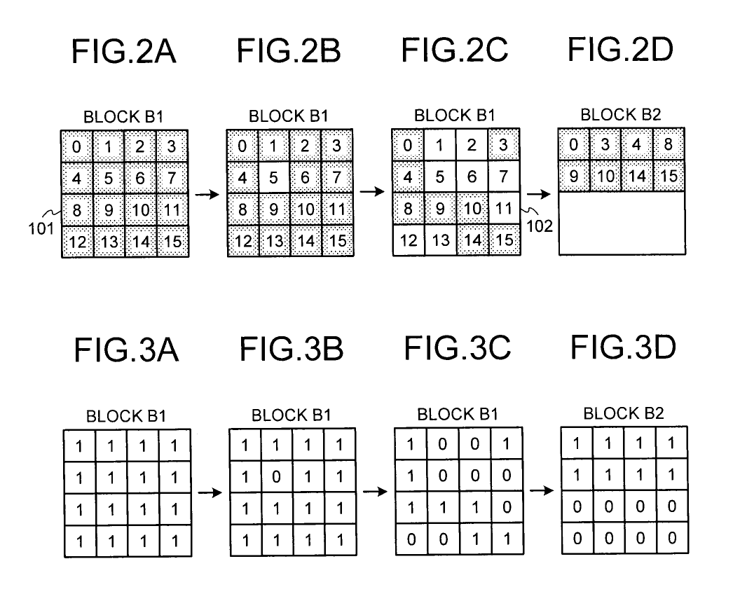

FIGS. 2A to 2D are diagrams illustrating an example of the compaction process in the semiconductor storage device 1. In FIGS. 2A to 2D, each square in which a numeral is written indicates a cluster. The cluster is a unit of data smaller than a page which is a write unit in the NAND memory 3. The data size of the cluster is not limited. Information used for the host 4 to instruct the semiconductor storage device 1 to perform reading and writing is called a logic address, and a unit of the logic address is called a sector. For example, a parity can be generated for user data (with 1 kilobyte) of two sectors, four code words in which the user data and the parity are combined can be added to one cluster (about 4 kilobytes), and one page can be set to have a size (about 16 kilobytes) corresponding to four clusters. In FIGS. 2A to 2D, for example, a block of the NAND memory 3 includes “4□4=16” clusters. The sizes of the sector, the cluster, the page, and the block are not limited to this example.

In FIGS. 2A to 2D, for example, validation and invalidation of the data on the NAND memory 3 are managed in the unit of the cluster. A hatched valid cluster 101 indicates valid data. An invalid cluster 102 illustrated against a white background indicates a cluster in which invalid data is stored.

Immediately after the user data received from the host 4 and the corresponding parity are written on the NAND memory 3, as in FIG. 2A, all of the data are updated to the latest valid data in a block B1 of the NAND memory 3. However, when a time passes and the semiconductor storage device 1 receives update data (data with the same logic address as that of the data written on the block B1) from the host 4, the data before the update become invalid, and thus some of the data become invalid, as in FIG. 2B.

Thereafter, when a time further passes, the invalid data increase in the block B1, as in FIG. 2C. Data may not be overwritten at the positions of the invalid data of the block B1 at this time. Therefore, the block B1 is left alone, the capacity corresponding to the invalid data in the block B1 may be unusable and wasted. Therefore, the valid data of the block B1 in FIG. 2C are copied to be filled and recorded to another block (block B2), as illustrated in FIG. 2D. Thus, all of the data recorded in the block B1 can be invalidated so that the block B1 can be erased. Thus, the process of copying valid data in a block including invalid data to be filled and written to another block refers to a compaction process.

When the compaction process is performed, it is necessary to specify a position at which data (valid data) to be copied is recorded in a block. In order to specify the position of the data, it is necessary to perform validation and invalidation management of the data on the NAND memory 3. The copy source determining unit 19 performs this management. For example, the copy source determining unit 19 performs the validation and invalidation management using bitmap data (valid data bitmap data) indicating the validation or invalidation of data of each cluster.

FIGS. 3A to 3D are diagrams illustrating an example of the valid data bitmap data. In FIGS. 3A to 3D, a cluster in which 1 is written indicates a valid cluster and a cluster in which 0 is written indicates an invalid cluster. The control unit 11 manages a correspondence between the logic address of data received from the host 4 and the address on the NAND memory 3. When the control unit 11 receives the data with the same logic address as that of the written data from the host 4, the control unit 11 controls writing the data in an empty area of the NAND memory 3. Thus, the data before the update becomes unnecessary. For example, the copy source determining unit 19 acquires the address on the NAND memory 3, on which writing has been performed, and the address of the data, which becomes unnecessary due to the reception of the update data, on the NAND memory 3 from the control unit 11 and updates the bitmap data. Further, the copy source determining unit 19 may determine whether the data is valid for each cluster by acquiring, from the control unit 11, the logic address requested to be written from the host 4 with reference to the correspondence between the logic address and the address on the NAND memory 3, and may update the bitmap data.

FIGS. 3A to 3D correspond to FIGS. 2A to 2D, respectively. When a time passes, as described above, the invalid data increases. That is, the invalid data increases, as in FIG. 3C. The copy source determining unit 19 searches for valid data (searches for the cluster with the value of 1) with reference to the valid data bitmap and determines the physical position of the valid data of copy source. The valid data bitmap is stored in, for example, the work RAM 16.

The copy source determining unit 19 notifies the copy performing unit 18 of the physical position of the valid data. The copy performing unit 18 controls the data transmission control unit 17 based on this notification and reads copy source data (valid data) from the NAND memory 3 to the data buffer 13 through the NAND controller 15 and the error correcting unit 14. Thereafter, the data passes through the error correcting unit 14 and the NAND controller 15 and is written to a copy destination block of the NAND memory 3. In the example of FIGS. 2A to 2D, a block (first region) of a reading source (copy source) is the block B1 and a block (second region) of a writing destination (copy destination) is the block B2.

In this embodiment, as described above, the copy source determining unit 19 and the copy performing unit 18 can be considered as a compaction processing unit, since the copy source determining unit 19 and the copy performing unit 18 perform the compaction process. The copy source determining unit 19 and the copy performing unit 18 may be configured as one compaction processing unit without separation of the copy source determining unit 19 and the copy performing unit 18.

In the compaction process, the data read from the NAND memory 3 is normally subjected to the error correcting process by the decoding unit 142 of the error correcting unit 14. The error correcting unit 14 has a maximum correction capability (for example, the maximum correction capability of 40 bits for data of 1 KB) appropriately determined in advance. The encoding unit 141 is configured to have the maximum correction capability and performs the error correction coding process to generate a parity. Normally, the decoding unit 142 has a capability to correct an error corresponding to the maximum correction capability.

When the user data requested to be read from the host 4 is read from the NAND memory 3, the decoding unit 142 needs to correct an error corresponding to the maximum correction capability. On the other hand, the compaction process is not a process of returning the data to the host 4 but a process of moving the data inside the semiconductor storage device 1. However, since it takes some time to perform the error correcting process on the assumption of the maximum correction capability, reading and writing data from and to the NAND memory 3 may not be performed during the execution of the compaction process. Accordingly, reduction in a time required to perform the compaction process as an internal process results in an improvement in responsiveness of the semiconductor storage device 1 from the viewpoint of the host 4.

In this embodiment, at the time of performing the compaction process, the time required to perform the compaction process is reduced by not correcting all of the errors which can be corrected by the decoding unit 142 (not correcting some of the correctable errors).

In this embodiment, the error correcting process is not performed, when only a predetermined sufficiently small number of error bits with respect to the maximum correction capability is detected. For example, when the number of error bits equal to or less than ⅕ of the maximum correction capability occurs, the error correcting process is controlled not to be performed. Thus, since the error correcting process is not performed, the time required to perform the compaction process can be reduced, and thus the responsiveness of the semiconductor storage device 1 is improved from the viewpoint of the user.

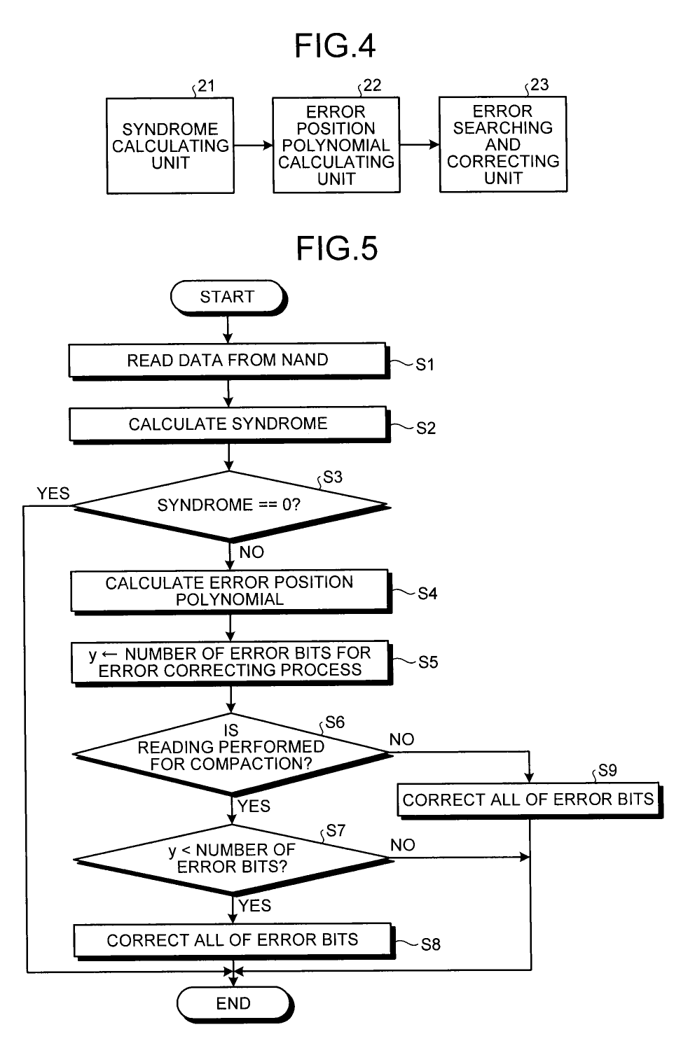

The error correcting process in the compaction process according to this embodiment will be described. FIG. 4 is a diagram illustrating an example of the configuration of the decoding unit 142 according to this embodiment. In FIG. 4, the configuration is exemplified in which the BCH code is used as an error correction code. When the BCH code is used as the error correction code, a syndrome calculating unit 21 performs a syndrome calculating process based on the input code words in the error correcting process. Next, an error position polynomial calculating unit 22 calculates an error position polynomial using the syndrome calculation result and also acquires the number of error bits. Then, an error searching and correcting unit 23 perform the error correcting process by detecting an error position and reversing the bit at the detected error position.

There is no limitation on the size of the code words including the user data and the corresponding parity. However, to facilitate the process, a unit (one cluster in the above-mentioned example) of data used to determine the validation and invalidation of the data is preferably an integer multiple of the size of the code word. Here, to facilitate the description, the size of the code word is assumed to be one cluster.

In this embodiment, when the number of error bits required by the error position polynomial calculating unit 22 is equal to or less than a first threshold value (for example, ⅕ of the maximum correction capability) at the time of performing the compaction process, a subsequent process, that is, the process of the error searching and correcting unit 23 is not performed. In this control, for example, the control unit 11 may preset the fact that “the process of the error searching and correcting unit 23 is not performed when the number of error bits is equal to or less than ⅕ of the maximum correction capability” in the decoding unit 142.

FIG. 5 is a flowchart illustrating an example of the order of the error correcting process in the memory controller 2 according to this embodiment. For example, when the memory controller 2 makes a request to read data from the host 4 or determines to perform the compaction process, the memory controller 2 reads data (the user data and the parity) from the NAND memory 3 (NAND) (step S1).

The syndrome calculating unit 21 of the error correcting unit 14 performs the syndrome calculating process based on the data read from the NAND memory 3 (step S2). When the syndrome calculating unit 21 determines whether a syndrome is 0 (step S3). When the syndrome is 0 (Yes in step S3), the syndrome calculating unit 21 determines that no error occurs and ends the process.

Conversely, when the syndrome is not 0 (No in step S3), the error position polynomial calculating unit 22 calculates an error position polynomial using the syndrome calculation result and acquires the number of error bits (step S4). When error position polynomial calculating unit 22 sets y as the first threshold value determined in advance for the number of error bits (step S5). The error position polynomial calculating unit 22 determines whether the reading in step S1 is reading for the compaction process (step S6). The copy performing unit 18 or the control unit 11 is assumed to notify the decoding unit 142 of information obtained by determining whether the reading in step S1 is the reading for the compaction process.

When the reading in step S1 is the reading for the compaction process (Yes in step S6), the error position polynomial calculating unit 22 determines whether y is less than the number of error bits (step S7). When y is less than the number of error bits (the number of error bits is greater than y) (Yes in step S7), the error searching and correcting unit 23 detects all of the error positions corresponding to the number of error bits, corrects all of the error bits (step S8), and ends the error correcting process. Conversely, when y is equal to or greater than the number of error bits (the number of error bits is equal to or less than y) (No in step S7), the process of the error searching and correcting unit 23 is not performed and the error correcting process ends.

When the reading in step S1 is not the reading for the compaction process (No in step S6), the error searching and correcting unit 23 detects all of the error positions corresponding to the number of error bits, corrects all of the error bits (step S9), and ends the error correcting process.

When a request for reading data from the host 4 is performed after the above-described processes, the user data (or the user data read from the NAND memory 3, when there is no error) subjected to the error correction process is transmitted to the host 4. On the other hand, when y is equal to or greater than the number of error bits in the compaction process (including a case in which there is no error), the user data and the parity read from the NAND memory 3 are written on the data buffer 13. When y is less than the number of error bits in the compaction process, all of the error bits are corrected and the user data and the parity subjected to the error correcting process are written on the data buffer 13. In addition, the user data and the parity read from the data buffer 13 are written on a block different from the read block on the NAND memory 3 through the NAND controller 15. When the number of error bits exceeds the maximum correction capability, for example, a process of notifying the host 4 that the error correcting process is not enabled is performed, as in a normal process.

The user data read to the data buffer 13 without execution of the error correcting process has to be written on the NAND memory 3 along with the parity read to the same data buffer 13 without re-execution of the error correction coding process. This is because data (not used in the error correcting process) read from the NAND memory 3 is necessary in order to correct the data with an error which is stored in the data buffer 13 to be original data without an error. Therefore, when the copy performing unit 18 writes data to be written on the NAND memory 3 on the NAND memory 3 without execution of the error correction coding process by appropriately controlling the data transmission control unit 17, control is performed such that the process performed by the encoding unit 141 is not performed.

With regard to the data that is subjected to the error correcting process and read to the data buffer 13, the user data is subjected again to the error correction coding process and is written on the NAND memory 3. That is, after errors of the user data once read are corrected, the error correction coding process is performed again based on the user data. When the number of error bits increases due to deterioration over time, the number of error bits exceeds y. In this case, since an error occurring after execution of re-writing can be corrected with respect to the error of the maximum correction capability by performing the error correction coding process again, the error correction capability can be further improved, compared to a case in which the error correction coding process is not performed.

The decoding unit 142 may include a decoding control unit (not illustrated) that controls the entire decoding process and cause the decoding control unit to control the determinations of steps S3, S6, and S7 and each unit depending on the results of these determinations.

The example has been described above in which the first threshold value (y) is determined as a ratio, such as ⅕ of the maximum correction capability, with respect to the maximum correction capability. However, the first threshold value (y) may be determined as a ratio between a data length and the number of error bits. That is, when the number of error bits is sufficiently smaller than the data length of the data to be corrected, the process of the error searching and correcting unit 23 may not be performed likewise.

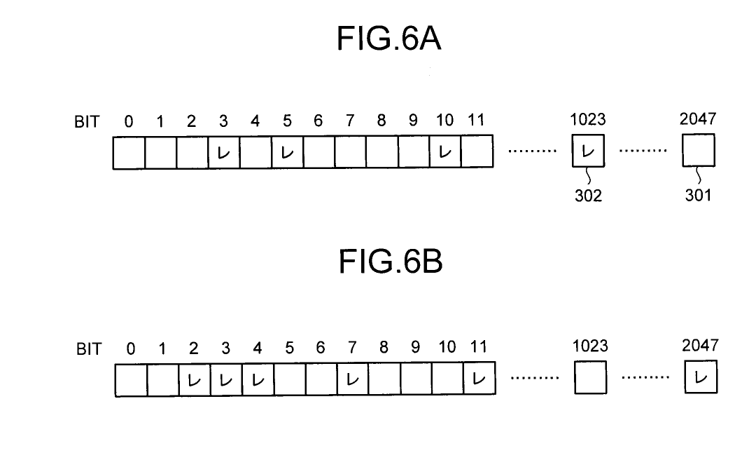

FIGS. 6A and 6B are diagrams illustrating examples of error distributions. For example, the error correcting process is assumed to be performed on data with 2048 bits, as in FIGS. 6A and 6B. In FIGS. 6A and 6B, a bit (for example, a bit 302) with a “□” mark is a bit with an error and a bit (for example, a bit 301) without the “□” mark is a bit without an error.

In FIG. 6A, the number of error bits is four, and errors are present at the 3rd, 5th, 10th, and 1023rd bits. In general, in an error position detecting process, error positions are detected by sequentially substituting candidates of a root to an error position polynomial. This detection is performed until the error positions corresponding to the number of error bits are detected. In FIG. 6B, an example is illustrated in which the number of error bits are six, and the 2047th bit is an error bit. Even in this case, six bits are a very small number with respect to the data length of 2048 bits, but the error position detecting process is performed up to the 2047th bit.

In the example of FIG. 6A, when the candidates of the corresponding root are substituted in order from the 0th bit, the process may not end until the substituting process at the 1023rd bit which is the 4th error is performed. On the other hand, 4 bits are a very small number with respect to the data length of 2048 bits and an error occurrence probability is not high. For example, when the data length is 12 bits, 4 bits are quite a large number with respect to the data length, and thus an error occurrence probability is high. Thus, the degree of influence of an error is different depending on the data length with respect to 4 bits.

Even when 4 bits are the sufficiently small number of error bits with respect to the data length of 2048 bits, the error position detecting process is performed up to the 1023rd bit, and thus the amount of processing is not small, as in FIG. 6A. On the other hand, when the maximum correction capability of the error correcting unit 14 is sufficiently higher than 4 bits and the number of error bits is sufficiently smaller than the data length of data to be corrected, a considerable problem may not occur in spite of the fact that the error correcting process is not performed in the compaction process. The same applies to the case of FIG. 6B. Accordingly, the first threshold value can be set to be larger, as the data length is longer. For example, the first threshold value is set to be 1/100 of the data length of the data to be corrected (here, when 1/100 of the data length of the data to be corrected is less than the maximum correction capability). Alternatively, a method can be considered in which the smaller value (or the larger value) between 1/100 of the data length of the data to be corrected and ⅕ of the maximum correction capability is set as the first threshold value.

In this embodiment, the example in which the BCH code is used has been described. However, an error correction code other than the BCH code can be used, as long as the number of error bits is calculated during the error correcting process. When an error correction code other than the BCH code is used, whether to perform a subsequent process may be determined based on the number of error bits at the time of calculating the number of error bits, as in the above-described example.

In this embodiment, as described above, the process of the error searching and correcting unit 23 is configured not to be performed at the time of performing the compaction process, when the number of error bits of the data read from the NAND memory 3 is equal to or less than the first threshold value. Thus, since the time required to perform the compaction process can be reduced, the responsiveness of the semiconductor storage device 1 can be improved from the viewpoint of the host 4.

### Second Embodiment

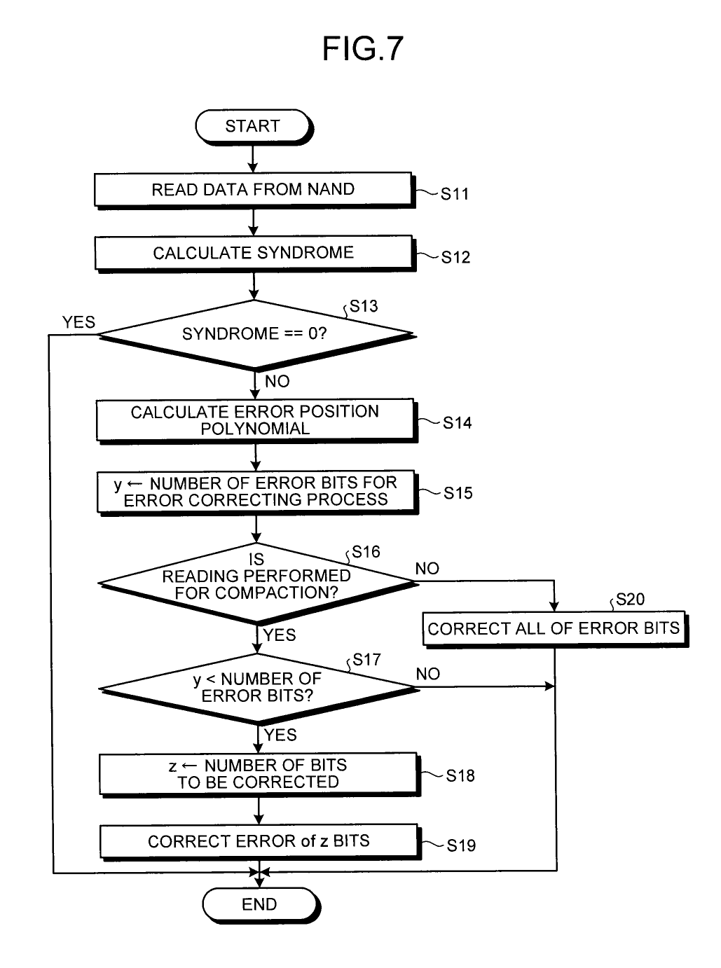

FIG. 7 is a flowchart illustrating an example of the order of an error correcting process according to a second embodiment. The configuration of the semiconductor storage device 1 of this embodiment is the same as that of the first embodiment. Differences between the first and second embodiments will be described below.

In the first embodiment, whether to perform the subsequent process of the error searching and correcting unit 23 has been determined in accordance with the number of error bits. In this embodiment, when the number of error bits is equal to or less than the first threshold value (for example, ⅓ of the maximum correction capability), the error correcting process (the process of the error searching and correcting unit 23) is not performed. When the number of error bits is greater than the first threshold value, the error correcting process is performed on some of the errors. When the error correcting process is performed on some of the errors, the error correcting process is performed until the number of error bits after the error correcting process becomes the remaining number of bits determined in advance. For example, when the number of error bits is equal to or less than the first threshold value (for example, ⅓ of the maximum correction capability), the process of the error searching and correcting unit 23 is performed on some of the error bits and the error correcting process is performed until the remaining number of error bits becomes the remaining number of bits. When the number of error bits is greater than the first threshold value, the error correcting process is performed on all of the error bits.

The first threshold value is a predetermined value. The first threshold value may be any value, as long as the first threshold value is less than the maximum correction capability. For example, the first threshold value can be determined to ⅓ or the like of the maximum correction capability. The remaining number of bits is the remaining number of error bits when some of the errors are corrected. The remaining number of bits may be any value, as long as the remaining number of bits is less than the first threshold value. For example, the remaining number of bits may be determined in advance as a fixed value (for example, ⅕ of the maximum correction capability).

Specifically, as illustrated in FIG. 7, steps S1 to S14 are first performed, as in steps S1 to S7 of the first embodiment. The error position polynomial calculating unit 22 sets y as the first threshold value determined in advance for the number of error bits (step S15). The error position polynomial calculating unit 22 determines whether the reading of step S11 is reading for the compaction process (step S16).

When the reading is not the reading for the compaction process (No in step S16), the error searching and correcting unit 23 detects all of the error positions corresponding to the number of error bits, corrects all of the error bits (step S20), and ends the process.

When the reading is the reading for the compaction process (Yes in step S16), the error position polynomial calculating unit 22 determines whether y is less than the number of error bits (the number of error bits is greater than y) (step S17).

When y is less than the number of error bits (Yes in step S17), the error position polynomial calculating unit 22 acquires the number of error bits to be corrected (the number obtained by subtracting the above-described remaining number of bits from the number of error bits) and sets the number of error bits to be corrected to z (step S18). The error searching and correcting unit 23 detects the error positions of z bits, corrects the error bits of the detected z bits (step S19), and ends the process. Specifically, for example, the error searching and correcting unit 23 detects whether the error positions are error positions in order from the 0th bit of correction target data and ends the error position detecting process when the error positions corresponding to the number of correction bits are detected. Then, the error correcting process is performed on the detected error positions.

When y is equal to or greater than the number of error bits (the number of error bits is equal to or less than y) (No in step S17), the process of the error searching and correcting unit 23 is not performed and the process ends.

When a partial error correcting process is performed, the error correction coding process is not performed at the writing time on a copy destination block of the NAND memory 3, and the user data and the parity subjected to the partial error correcting process are directly written on the NAND memory 3.

When the number of error bits acquired by the error position polynomial calculating unit 22 is sufficiently smaller than the data length of the correction target data, a method of correcting only some of the error bits and stopping the error correcting process can be considered. That is, a method can be used in which the data length of the correction target data is considered when the above-described first threshold value is determined.

For example, when the data length is 2048 bits and the number of error bits such as 4 bits or 6 bits is sufficiently smaller than 2048 bits, as illustrated in FIGS. 6A and 6B, some of the error bits are corrected. For example, when the number of error bits is equal to or less than 1/100 of the data length, some of the error bits are corrected. When the number of error bits is greater than 1/100 of the data length, all of the error bits are corrected. That is, for example, a method of setting the first threshold value to 1/100 of the data length can be used. Further, a method can be used in which the remaining number of bits is determined to the fixed value as the remaining number of error bits and the number of bits obtained by subtracting the remaining number of bits from the number of error bits is set to the number of correction bits, when some of the errors are corrected, as described above. Furthermore, the number of correction bits may be determined in accordance with a ratio with respect to the number of error bits. For example, ½ of the number of error bits can be corrected. Likewise, the remaining number of bits may be determined in accordance with the data length.

In the above description, when the number of error bits is less than the first threshold value, the error correcting process is not performed. When the number of error bits is greater than the first threshold value, the partial error correcting process is performed. As the method of using an operation of performing the partial error correcting process, in addition to the above-described methods, some of the errors may be corrected, when the number of error bits is equal to or less than the first threshold value. When the number of error bits is greater than the first threshold value, all of the errors may be corrected.

In this embodiment, as described above, all of the errors are not corrected, when the number of error bits is equal to or less than the first threshold value. The error correcting process is performed, until the number of error bits subjected to the error correcting process becomes the remaining number of bits determined in advance. When the number of error bits becomes the remaining number of bits, the error correcting process stops. Therefore, since the time required to perform the compaction process can be reduced, the responsiveness of the semiconductor storage device 1 can be improved from the viewpoint of the host 4.

Further, an operation of combining the process of correcting all of the number of the error bits and the operation of this embodiment may be performed. That is, the combining operation is classified into three cases using two kinds of threshold values in accordance with the number of error bits: (1) the error correcting process (the process of the error searching and correcting unit 23) is not performed, (2) some of the errors are corrected, and (3) all of the error bits are corrected. For example, when the number of error bits is equal to or less than the first threshold value (for example, ⅕ of the maximum correction capability), the process of the error searching and correcting unit 23 is not performed. When the number of error bits is greater than the first threshold value and is equal to or less than the second threshold value (for example, ⅓ of the maximum correction capability), some of the error bits is subjected to the process of the error searching and correcting unit 23 until the remaining number of error bits becomes the remaining number of bits. When the number of error bits is greater than the second threshold value, all of the error bits are subjected to the process of the error searching and correcting unit 23. In this case, the second threshold value is set to be greater than the first threshold value. The remaining number of bits may be determined to any value, as long as the remaining number of bits is less than the second threshold value. For example, the remaining number of bits can be set to be equal to the first threshold value.

### Third Embodiment

Hereinafter, an error correcting process according to a third embodiment will be described. The configuration of a semiconductor storage device 1 of this embodiment is the same as that of the first embodiment. Differences between this embodiment and the first or second embodiment will be described below.

In the first and second embodiments, the first threshold value (or the first threshold value and the remaining number of bits) has been set in advance as the reference of the maximum correction capability or/and the data length of a correction target of the error correcting unit 14. In this embodiment, an example will be described in which the values are determined using the property of the NAND memory 3. An operation of this embodiment is the same as that of the first or second embodiment except that a method of determining the first threshold value (or the first threshold value and the remaining number of bits) is different.

A NAND flash memory is widely known to deteriorate when the number of erasures increases. The deterioration in the NAND flash memory is observed as the form of an increase in the number of error bits of stored data. Accordingly, when the number of erasures of a writing destination block is small, it is rarely considered that errors increase in a minute up to the number of bits greater than the maximum correction capability of the error correcting unit 14 in spite of the fact that the error bits are present somewhat.

In this embodiment, using this property, the first threshold value (or the first threshold value and the remaining number of bits) is determined in accordance with the number of erasures of a copy destination block. In general, the number of erasures of a block is managed by the control unit 11. Therefore, the control unit 11 determines the first threshold value (or the first threshold value and the remaining number of bits) using information regarding the number of erasures and sets the determined value in the decoding unit 142. For example, the control unit 11 retains a correspondence between the number of erasures and the first threshold value (or the first threshold value and the remaining number of bits) as a table (threshold setting table) and determines the first threshold value (or the first threshold value and the remaining number of bits), referring to the table in accordance with the number of erasures. Further, a method may be used in which the first threshold value (or the first threshold value and the remaining number of bits) is determined by expressing the first threshold value (or the first threshold value and the remaining number of bits) as a function of the number of erasures and obtaining a value of the function using the number of erasures as an input.

Here, the example of performing the operation of the second embodiment has been described. However, even when the operation of the first embodiment is solely performed, the first threshold value can be determined in accordance with the following method of determining the first threshold value. Likewise, the remaining number of bits and the two threshold values (the first and second threshold values described in the second embodiment) of the case in which the operation is classified into the three cases using two threshold values described in the second embodiment can be determined in accordance with the following method.

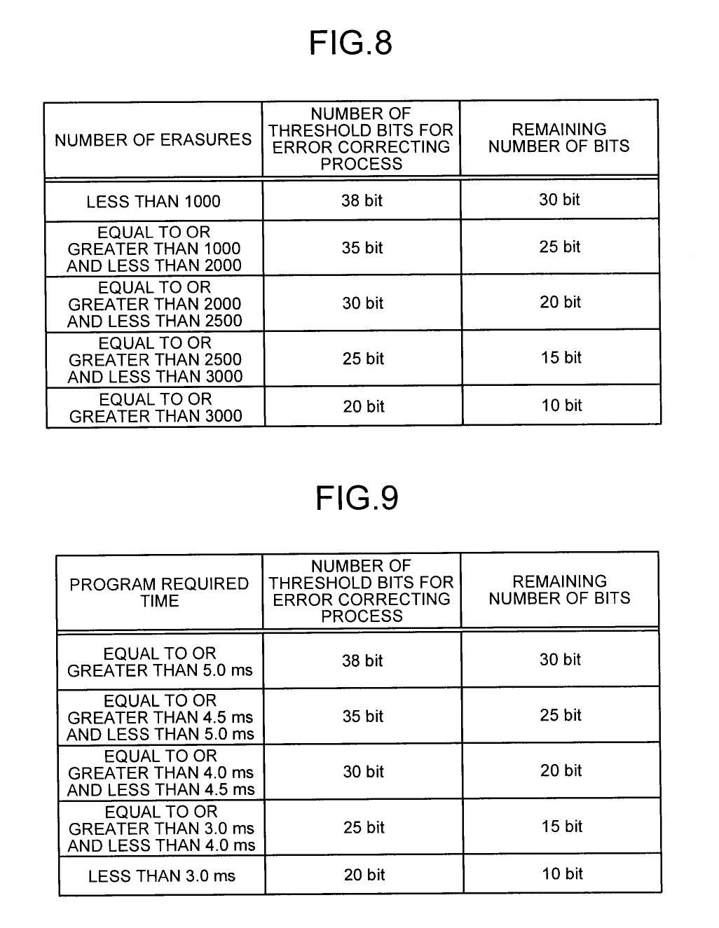

FIG. 8 is a diagram illustrating an example of a threshold setting table according to this embodiment. The control unit 11 retains a threshold setting table illustrated in FIG. 8. At the time of performing the compaction process, the control unit 11 determines the first threshold value and the remaining number of bits in accordance with the number of erasures of the copy destination block, referring to the threshold setting table. Each value in the threshold setting table is not limited to the example of FIG. 8. In FIG. 8, the maximum correction capability of the error correcting unit 14 is assumed to be 43 bits.

When the compaction process starts, the control unit 11 acquires the number of erasures of the copy destination block, referring to information regarding the number of erasures of each managed block. In the processes of steps S15 and S18 of FIG. 7, the control unit 11 sets the values of y and z based on the number of erasures of the copy destination block and the threshold setting table.

For example, when the number of erasures is 1700 times, the number of erasures corresponds to a range equal to or greater than 1000 times and less than 2000 times in FIG. 8. Therefore, the number of bits (first threshold value) of the threshold value used to perform the error correcting process is set to 35 bits. The remaining number of bits is set to 25 bits. Accordingly, when the number of error bits acquired by the error position polynomial calculating unit 22 is 40 bits, “z=40−25=15 bits” is set in step S18 of FIG. 7 and the process of detecting the error positions of the 15 bits and the error correcting process are performed in step S19.

In this embodiment, as described above, the threshold value used to determine whether the error correcting process is performed and the remaining number of bits at the time of performing the partial error correcting process are determined based on the number of erasures of the copy destination block at the time of performing the compaction process. Therefore, it is possible to obtain the same advantage as that of the second embodiment. Further, it is possible to perform the error correcting process suitable for the property of the NAND memory 3.

### Fourth Embodiment

Next, an error correcting process according to a fourth embodiment will be described. The configuration of a semiconductor storage device 1 according to this embodiment is the same as that of the first embodiment. Differences between this embodiment and the first or second embodiment will be described below.

In the third embodiment, the first threshold value and the remaining number of bits have been determined based on the number of erasures of the copy destination block. In this embodiment, the maximum number of error bits in a block at the time of performing the error correcting process is recorded for each block. At the time of performing the compaction process, in a copy destination block, the first threshold value and the remaining number of bits are determined in accordance with the previous maximum number of bits at the time of reading data from this block. An operation of this embodiment is the same as that of the first or second embodiment except that a method of determining the first threshold value (or the first threshold value and the remaining number of bits) is different.

In a block in which the maximum number of error bits is large, there is a high probability that the number of error bits increases even for write data from the current time by the compaction process. In the block in which the maximum number of error bits is large, it is desirable to set the first threshold value, which is used to determine whether the error correcting process is performed, to be small and to decrease data not subjected to the error correcting process. Further, in the block in which the maximum number of error bits is large, it is desirable to set the remaining number of bits to be small.

In this embodiment, for example, when reading is started from the NAND memory 3, the control unit 11 acquires the number of error bits after encoding of each read data from the decoding unit 142 and records the maximum number of error bits of each block as block error information. When the reading is performed from the same block a plurality of times, the maximum number of error bits is updated in each reading. At the time of performing the compaction process, the control unit 11 acquires the maximum number of error bits in the copy destination block, referring to the block error information.

For example, the control unit 11 sets, as the first threshold value, a value obtained by subtracting the maximum number of error bits in the copy destination block from the maximum correction capability and sets a value obtained by subtracting 10 bits from the first threshold value as the remaining number of bits. Further, the method of acquiring the first threshold value and the remaining number of bits based on the maximum number of error bits is not limited to this example. As in the third embodiment, the first threshold value and the remaining number of bits may be determined by the method of retaining the correspondence between the maximum number of error bits and the first threshold value (or the first threshold value and the remaining number of bits) as a table (threshold setting table) and referring the table.

Further, the maximum number of error bits may be recorded every time at each reading, a history of the maximum numbers of error bits may be recorded as history information, the maximum number of error bits of the copy destination block at the time of performing the compaction process may be estimated based on the history information by extrapolation or the like, and the first threshold value and the remaining number of bits may be acquired based on the estimation result. For example, when the difference between the two recent maximum numbers of error bits based on the history information is 10 bits at the time of performing the compaction process, there is a probability that 10-bit errors may increase at the time of correcting the subsequent error. Therefore, the remaining number of bits is decreased by 10 bits and the first threshold value is increased by 10 bits.

Here, the example in which the operation of the second embodiment is performed has been described. However, even when the operation of the first embodiment is solely performed, the first threshold value can be determined likewise based on the maximum number of error bits. Likewise, the remaining number of bits and the two threshold values (the first and second threshold values described in the second embodiment) of the case in which the operation is classified into the three cases using two threshold values described in the second embodiment can be determined based on the maximum number of error bits.

In this embodiment, as described above, the threshold value used to determine whether the error correcting process is performed and the remaining number of bits at the time of performing the partial error correcting process are determined based on the maximum number of error bits of the copy destination block at the time of performing the compaction process. Therefore, it is possible to obtain the same advantage as that of the second embodiment. Further, it is also possible to perform the error correcting process in accordance with an error occurrence situation of the NAND memory 3.

### Fifth Embodiment

Next, an error correcting process according to a fifth embodiment will be described. The configuration of a semiconductor storage device 1 according to this embodiment is the same as that of the first embodiment. Differences between this embodiment and the first or second embodiment will be described below.

In the fourth embodiment, the maximum number of error bits has been recorded for each block, and the first threshold value and the remaining number of bits have been determined based on the maximum number of error bits. In this embodiment, a time (program required time) taken to perform writing (program) is measured and recorded for each block. For example, when a block is formed by a plurality of pages, the program required time is measured for each page and the maximum value in the block is recorded. At the time of performing the compaction process, in the copy destination block, the first threshold value and the remaining number of bits are determined in accordance with the program required time, when data is written previously on this block. An operation of this embodiment is the same as that of the first or second embodiment except that a method of determining the first threshold value (or the first threshold value and the remaining number of bits) is different.

A NAND flash memory has a property in which it takes some time to perform writing with deterioration in a cell. Accordingly, when the degree of the deterioration in a cell is known based on a writing time, it can be estimated how many error bits occur at the time of reading the subsequently written data. In this embodiment, the first threshold value and the remaining number of bits are determined in accordance with the program required time using this property.

In a block in which the program required time is long, there is a high probability that the number of error bits may increase for the write data from the current time by the compaction process. In this case, it is desirable to set the first threshold, which is used to determine the error correcting process, to be small and to decrease data not subjected to the error correcting process. Further, in a block in which the program required time is long, it is desirable to set the remaining number of bits to be small.

In this embodiment, for example, the control unit 11 retains a correspondence between the program required time, and the first threshold value and the remaining number of bits as a table (threshold setting table) and determines the first threshold value and the remaining number of bits in accordance with the program required time, referring to the table.

FIG. 9 is a diagram illustrating an example of the threshold setting table according to this embodiment. The control unit 11 retains the threshold setting table illustrated in FIG. 9. At the time of performing the compaction process, the control unit 11 determines the first threshold value and the remaining number of bits in accordance with the program required time of a copy destination, referring to the threshold setting table. Each value in the threshold setting table is not limited to the example of FIG. 9. In FIG. 9, the maximum correction capability of the error correcting unit 14 is assumed to be 43 bits.

When the compaction process starts, the control unit 11 acquires the program required time of the copy destination block, referring to information regarding the program required time of each managed block. In the processes of steps S15 and S18 of FIG. 7, the control unit 11 sets the values of y and z based on the program required time of the copy destination block and the threshold setting table.

For example, when the program required time is 2.5 ms, the program required time corresponds to a range equal to or greater than 2 ms and less than 3 ms in FIG. 9. Therefore, the number of bits (first threshold value) of the threshold value used to perform the error correcting process is set to 30 bits. The remaining number of bits is set to 20 bits. Accordingly, when the number of error bits acquired by the error position polynomial calculating unit 22 is 32 bits, “z=32−20=12 bits” is set in step S18 of FIG. 7 and the process of detecting the error positions corresponding to 12 bits and the error correcting process are performed in step S19.

Information regarding the program required time of each block may be measured at each time of performing writing (program) and the latest value may be normally retained. Alternatively, a history of the program required times may be retained, the program required time of the copy destination block at the time of performing the compaction process may be estimated by extrapolation or the like based on the history, and the first threshold value or the like may be set using the estimated program required time and the threshold setting table.

In this embodiment, as described above, the threshold value used to determine whether the error correcting process is performed and the remaining number of bits at the time of performing the partial error correcting process are determined based on the program required time of the copy destination block at the time of performing the compaction process. Therefore, it is possible to obtain the same advantage as that of the second embodiment. Further, it is also possible to perform the error correcting process in accordance with an error occurrence situation of the NAND memory 3.

### Sixth Embodiment

Next, an error correcting process according to a sixth embodiment will be described. The configuration of a semiconductor storage device 1 according to this embodiment is the same as that of the first embodiment. Differences between this embodiment and the first or second embodiment will be described below.

In the fifth embodiment, the first threshold value and the remaining number of bits have been determined based on the program required time of the copy destination block at the time of performing the compaction process. In this embodiment, a time (erase required time) taken to perform erasure is measured and recorded for each block. At the time of performing the compaction process, in the copy destination block, the first threshold value and the remaining number of bits are determined in accordance with the erase required time, when data is erased previously on this block. An operation of this embodiment is the same as that of the first or second embodiment except that a method of determining the first threshold value (or the first threshold value and the remaining number of bits) is different.

A NAND flash memory has a property in which the erase required time is shortened with deterioration in a cell. Accordingly, when the degree of the deterioration in a cell is known based on the erase required time, it can be estimated how many error bits occur at the time of reading the subsequently written data. In this embodiment, the first threshold value and the remaining number of bits are determined in accordance with the erase required time using this property.

In a block in which the erase required time is short, there is a high probability that the number of error bits may increase for the write data from the current time by the compaction process. In this case, it is desirable to set the first threshold, which is used to determine the error correcting process, to be small and to decrease data not subjected to the error correcting process. Further, in a block in which the erase required time is short, it is desirable to set the remaining number of bits to be small.

In this embodiment, for example, the control unit 11 retains a correspondence between the erase required time, and the first threshold value and the remaining number of bits as a table (threshold setting table) and determines the first threshold value and the remaining number of bits in accordance with the erase required time, referring to the table.

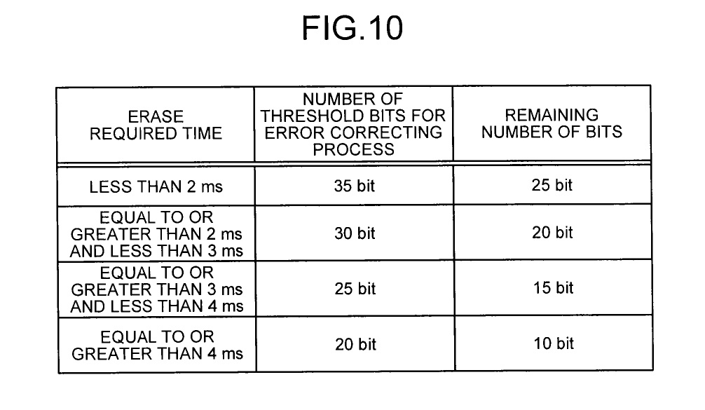

FIG. 10 is a diagram illustrating an example of the threshold setting table according to this embodiment. The control unit 11 retains the threshold setting table illustrated in FIG. 10. At the time of performing the compaction process, the control unit 11 determines the first threshold value and the remaining number of bits in accordance with the erase required time of a copy destination, referring to the threshold setting table. Each value in the threshold setting table is not limited to the example of FIG. 10. In FIG. 10, the maximum correction capability of the error correcting unit 14 is assumed to be 43 bits.

When the compaction process starts, the control unit 11 acquires the erase required time of the copy destination block, referring to information regarding the erase required time of each managed block. In the processes of steps S15 and S18 of FIG. 7, the control unit 11 sets the values of y and z based on the erase required time of the copy destination block and the threshold setting table.

For example, when the erase required time is 3.8 ms, the erase required time corresponds to a range equal to or greater than 3.5 ms and less than 4.0 ms in FIG. 10. Therefore, the number of bits (first threshold value) of the threshold value used to perform the error correcting process is set to 25 bits. The remaining number of bits is set to 15 bits. Accordingly, when the number of error bits acquired by the error position polynomial calculating unit 22 is 32 bits, “z=32−15=17 bits” is set in step S18 of FIG. 7 and the process of detecting the error positions corresponding to 17 bits and the error correcting process are performed in step S19.

Information regarding the erase required time of each block may be measured at each time of performing erasing and the latest value may be normally retained. Alternatively, a history of the erase required times may be retained, the erase required time of the copy destination block at the time of performing the compaction process may be estimated by extrapolation or the like based on the history, and the first threshold value or the like may be set using the estimated erase required time and the threshold setting table.

In this embodiment, as described above, the threshold value used to determine whether the error correcting process is performed and the remaining number of bits at the time of performing the partial error correcting process are determined based on the erase required time of the copy destination block at the time of performing the compaction process. Therefore, it is possible to obtain the same advantage as that of the second embodiment. Further, it is also possible to perform the error correcting process in accordance with an error occurrence situation of the NAND memory 3.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor storage device comprising:
a non-volatile semiconductor memory;
an encoding unit that performs an error correction coding process on data to be written on the non-volatile semiconductor memory to generate a parity;
a writing control unit that writes the data and the parity on the non-volatile semiconductor memory;
a decoding unit that performs an error correcting process based on the data and the parity read from the non-volatile semiconductor memory; and
a compaction processing unit that performs a compaction process of writing valid data of the data and the parity stored in a first region which is a region with a predetermined size in the non-volatile semiconductor memory on a second region, which is a region with a predetermined size other than the first region of the non-volatile semiconductor memory,
wherein the decoding unit includes
a syndrome calculating unit that calculates a syndrome based on the data and the parity read from the non-volatile semiconductor memory,
an error position polynomial calculating unit that calculates an error position polynomial based on the syndrome and acquires the number of error bits based on the error position polynomial,
an error searching and correcting unit that acquires an error position based on the error position polynomial and performs error correction of the acquired error position, and
wherein at the time of performing the compaction process, the processes of the syndrome calculating unit and the error position polynomial calculating unit are performed based on the valid data, and the valid data is written on the second region without performing the process of the error searching and correcting unit, when the number of error bits acquired by the error position polynomial calculating unit is equal to or less than a first threshold value.

2. The semiconductor storage device according to claim 1, wherein when the number of error bits acquired by the error position polynomial calculating unit is greater than the first threshold value, the process of the error searching and correcting unit is performed.

3. The semiconductor storage device according to claim 2, wherein when the number of error bits acquired by the error position polynomial calculating unit is greater than the first threshold value, the error searching and correcting unit detects and corrects error positions corresponding to all of the bits of the number of error bits.

4. The semiconductor storage device according to claim 2, wherein when the number of error bits acquired by the error position polynomial calculating unit is greater than the first threshold value, the error searching and correcting unit detects and corrects error positions corresponding to the number of correction bits less than the number of error bits.

5. The semiconductor storage device according to claim 2, wherein when the number of error bits acquired by the error position polynomial calculating unit is greater than the first threshold value and is equal to or less than a second threshold value, the error searching and correcting unit detects and corrects error positions corresponding to the number of correction bits less than the number of error bits, and
when the number of error bits is greater than the second threshold value, the error searching and correcting unit detects and corrects error positions corresponding to all of the bits of the number of error bits.

6. The semiconductor storage device according to claim 1, wherein the first threshold value is determined based on a maximum correction capability of the decoding unit.

7. The semiconductor storage device according to claim 1, wherein the first threshold value is determined based on a data length of data to be decoded.

8. The semiconductor storage device according to claim 1, further comprising:
a control unit that records the number of erasures for each region with the predetermined size,
wherein the first threshold value is determined based on the number of erasures of the second region.

9. The semiconductor storage device according to claim 1, further comprising:
a control unit that records a maximum number of error bits for each region with the predetermined size,
wherein the first threshold value is determined based on the maximum number of error bits of the second region.

10. The semiconductor storage device according to claim 1, further comprising:
a control unit that manages a program required time for each region with the predetermined size,
wherein the first threshold value is determined based on the program required time of the second region.

11. The semiconductor storage device according to claim 1, further comprising:
a control unit that manages an erase required time for each region with the predetermined size,
wherein the first threshold value is determined based on the erase required time of the second region.

12. The semiconductor storage device according to claim 4,
wherein the correction bits are determined as a value obtained by subtracting a remaining number of bits from the number of error bits, and
the first threshold value and the remaining number of bits are determined based on a maximum correction capability of the decoding unit.

13. The semiconductor storage device according to claim 4,
wherein the correction bits are determined as a value obtained by subtracting a remaining number of bits from the number of error bits, and
the first threshold value and the remaining number of bits are determined based on a data length of data to be decoded.

14. The semiconductor storage device according to claim 4, further comprising:
a control unit that records the number of erasures for each region with the predetermined size,
wherein the correction bits are determined as a value obtained by subtracting a remaining number of bits from the number of error bits, and
the first threshold value and the remaining number of bits are determined based on the number of erasures of the second region.

15. The semiconductor storage device according to claim 4, further comprising:
a control unit that records a maximum number of error bits for each region with the predetermined size,
wherein the correction bits are determined as a value obtained by subtracting a remaining number of bits from the number of error bits, and
the first threshold value and the remaining number of bits are determined based on the maximum number of error bits of the second region.

16. The semiconductor storage device according to claim 4, further comprising:
a control unit that manages a program required time for each region with the predetermined size,
wherein the correction bits are determined as a value obtained by subtracting a remaining number of bits from the number of error bits, and
the first threshold value and the remaining number of bits are determined based on the program required time of the second region.

17. The semiconductor storage device according to claim 4, further comprising:
a control unit that manages an erase required time for each region with the predetermined size,
wherein the correction bits are determined as a value obtained by subtracting a remaining number of bits from the number of error bits, and
the first threshold value and the remaining number of bits are determined based on the erase required time of the second region.

18. A memory controller that controls a non-volatile semiconductor memory, the memory controller comprising:
an encoding unit that performs an error correction coding process on data to be written on the non-volatile semiconductor memory to generate a parity;
a writing control unit that writes the data and the parity on the non-volatile semiconductor memory;
a decoding unit that performs an error correcting process based on the data and the parity read from the non-volatile semiconductor memory; and
a compaction processing unit that performs a compaction process of writing valid data of the data and the parity stored in a first region which is a region with a predetermined size in the non-volatile semiconductor memory on a second region which is a region with a predetermined size other than the first region of the non-volatile semiconductor memory,
wherein at the time of performing the compaction process, when the number of error bits of the valid data is acquired and the number of error bits is equal to or less than a first threshold value, the error correcting process is not performed at least partially, and
when the number of error bits is greater than the first threshold value, the error correcting process is performed.

19. A memory controller that controls a non-volatile semiconductor memory, the memory controller comprising:
an encoding unit that performs an error correction coding process on data to be written on the non-volatile semiconductor memory to generate a parity;
a writing control unit that writes the data and the parity on the non-volatile semiconductor memory;
a decoding unit that performs an error correcting process based on the data and the parity read from the non-volatile semiconductor memory; and
a compaction processing unit that performs a compaction process of writing valid data of the data and the parity stored in a first region which is a region with a predetermined size in the non-volatile semiconductor memory on a second region which is a region with a predetermined size other than the first region of the non-volatile semiconductor memory,
wherein the decoding unit includes
a syndrome calculating unit that calculates a syndrome based on the data and the parity read from the non-volatile semiconductor memory,
an error position polynomial calculating unit that calculates an error position polynomial based on the syndrome and acquires the number of error bits based on the error position polynomial,
an error searching and correcting unit that acquires an error position based on the error position polynomial and performs error correction of the acquired error position, and
wherein at the time of performing the compaction process, the processes of the syndrome calculating unit and the error position polynomial calculating unit are performed based on the valid data, and the valid data is written on the second region without performing the process of the error searching and correcting unit, when the number of error bits acquired by the error position polynomial calculating unit is equal to or less than a first threshold value.
